(19) United States
(12) Patent Application Publication
(10) Pub. No.: US 2025/0236264 A1
(43) Pub. Date: Jul. 24, 2025

(54) WIPER BLADE

(71) Applicant: Ningbo Meiyi Packaging Products Co., Ltd., Ningbo (CN)

(72) Inventor: YANGCHUN DUAN, Ningbo (CN)

(21) Appl. No.: 18/417,224

(22) Filed: Jan. 19, 2024

(51) Int. Cl. B60S 1/38; B60S 1/40

(52) U.S. Cl. CPC B60S 1/3801; B60S 1/3851; B60S 1/40

(57) ABSTRACT

A wiper blade includes a flow guide shell, a connecting shell, a wiper blade body and a clip. A lower part of the flow guide shell is provided with an accommodating groove. An upper surface of the connecting shell is provided with a clip mounting groove. A lower surface of the connecting shell is provided with a wiper blade body mounting groove. The connecting shell is inserted into the accommodating groove to connect the clip mounting groove to the accommodating groove. The wiper blade body is inserted into the wiper blade body mounting groove. The clip is inserted into the clip mounting groove. A first limiting block is arranged on an inner wall of the clip mounting groove. And a lower surface of the first limiting block resists against an upper surface of the clip.

### TECHNICAL FIELD

The present disclosure relates to the technical field of windshield wiper devices, and in particular, to a wiper blade.

### BACKGROUND

As a tool for performing simple cleaning on a windshield of a motor vehicle to prevent rainwater and other dirt from affecting the line of sight, wipers are widely used in daily life.

In the prior art, the wiper generally includes a wiper blade, a wiper arm, and a connector that hinges the wiper blade to the wiper arm. The wiper blade generally includes a flow guide shell, a wiper blade body, a clip, and the like. The wiper blade body is configured to wipe rain and snow on a windshield, and a root part of the wiper blade body is connected to a lower part of the flow guide shell. The clip is generally a strip-shaped metal plate, which is arranged on the flow guide shell to adapt to the shape of the windshield and make the wiper blade body tightly abut against the windshield. However, the flow guide shell is generally soft, so that the clip cannot be tightly bonded with the flow guide shell, and the product shakes in the wiping process. Moreover, due to the unstable connection between the flow guide shell, the wiper blade body, and the clip, they may also rub and collide with each other during use, causing noise.

For this purpose, the present disclosure provides a wiper blade that can effectively solve the above problems. The wiper blade has a simple structure and stable connection, and can effectively reduce the noise.

### SUMMARY

In order to overcome the shortcomings of the prior art, the present disclosure provides a wiper blade. The wiper blade has a simple structure and stable connection, and can effectively reduce the noise.

The technical solution adopted by the present disclosure to solve the technical problem is as follows.

A wiper blade, includes: a flow guide shell, wherein a lower part of the flow guide shell is provided with an accommodating groove; a connecting shell, wherein an upper surface of the connecting shell is provided with a clip mounting groove; a lower surface of the connecting shell is provided with a wiper blade body mounting groove; the connecting shell is inserted into the accommodating groove to connect the clip mounting groove to the accommodating groove; a wiper blade body, wherein the wiper blade body is inserted into the wiper blade body mounting groove; and a clip, wherein the clip is inserted into the clip mounting groove; a first limiting block is arranged on an inner wall of the clip mounting groove; and a lower surface of the first limiting block resists against an upper surface of the clip.

As the improvement of the present disclosure, an extension direction of a lower surface of the first limiting block is matched with an extension direction of a groove bottom plane of the clip mounting groove; and the clip is clamped between the lower surface of the first limiting block and the groove bottom plane of the clip mounting groove.

As the improvement of the present disclosure, the connecting shell includes a first wall; two sides of the first wall extend upwards to form first side walls; upper parts of the two first side walls extend towards each other to form the first limiting block; and the clip mounting groove is formed between an upper surface of the first wall, inner surfaces of the first side walls, and the lower surface of the first limiting block.

As the improvement of the present disclosure, the two sides of the first wall extend downwards to form second side walls; lower parts of the two second side walls extend towards each other to form a second limiting block; and the wiper blade body mounting groove is formed between a lower surface of the first wall, inner surfaces of the second side walls, and an upper surface of the second limiting block.

As the improvement of the present disclosure, the wiper blade body is provided with an insertion part, and the insertion part is detachably inserted into the wiper blade body mounting groove.

As the improvement of the present disclosure, the wiper blade body further includes a fixed part and a wiping part; the fixed part is connected to a lower part of the insertion part; the wiping part is connected to one side of the fixed part facing away from the insertion part; a locking groove is formed between the insertion part and the fixed part; and the second limiting block is inserted into the locking groove.

As the improvement of the present disclosure, the wiping part is arranged in an inverted cypress shape, and a width of a lower part of the wiping part is less than a width of an upper part of the wiping part.

As the improvement of the present disclosure, two edges of the accommodating groove extend inwards to form a third limiting block, and an upper surface of the third limiting block resists against an edge of the lower surface of the first wall.

As the improvement of the present disclosure, a side surface of the first wall resists against a side wall surface of the accommodating groove; and outer surfaces of the first side walls and/or an upper surface of the first limiting block resist/resists against an upper wall surface of the accommodating groove.

As the improvement of the present disclosure, a protruding wind bearing part is arranged in the middle of an upper surface of the flow guide shell, and symmetrical arc-shaped transition surfaces are arranged on two sides of the wind bearing part.

As the improvement of the present disclosure, the wiper blade further includes two fixed shells, wherein the fixed shells are provided with first insertion slots, and an end portion of the flow guide shell, an end portion of the connecting shell, an end portion of the wiper blade body, and an end portion of the clip are inserted into the first insertion slots.

As the improvement of the present disclosure, the fixed shells further includes openings; the openings are communicated to the first insertion slots; and the wiper blade body penetrates through the openings.

As the improvement of the present disclosure, first locking parts are arranged on two sides of the fixed shells close to the openings, and the first locking parts are connected to the clip and/or the connecting shell.

As the improvement of the present disclosure, the wiper blade further includes a connecting shell, wherein a lower part of the connecting shell is connected to the middle of the clip and/or the middle of the connecting shell; and an upper part of the connecting shell is configured to be connected to a wiper arm.

As the improvement of the present disclosure, the connecting shell is provided with a second insertion slot; a second locking part is arranged at an edge of the second insertion slot; the flow guide shell and the connecting shell are inserted into the second insertion slot; and the second locking part is connected to the clip and/or the connecting shell.

As the improvement of the present disclosure, the wiper blade further includes a rotary cover body, wherein a connecting opening is arranged at the upper part of the connecting shell; the rotary cover body is rotatably connected to the connecting shell and opens or closes the connecting opening; and the connecting opening is configured to allow the wiper arm to be connected for use.

As the improvement of the present disclosure, the flow guide shell, the connecting shell, the wiper blade body, and the clip are all arranged in an arc shape.

The present disclosure has the following beneficial effects. Through the arrangement of the above structure, during use, the clip is mounted in the clip mounting groove; and the lower surface of the first limiting block resists against the upper surface of the clip, which can limit the clip in the clip mounting groove and effectively fix the clip. The wiper blade body is inserted into the blade mounting groove, which can fix the wiper blade body. The flow guide shell can effectively protect the connecting shell. The clip is arc-shaped and has a certain curvature. When driven by an external force, the wiper blade body can tightly abut against a surface of a windshield, and forces on all parts of the wiper blade body can be uniform, ensuring the usage effect of the product, ensuring that the wiper blade can effectively remove water and other impurities from the surface of the windshield, and ensuring that a user can observe road conditions through the windshield. Moreover, the connecting shell is used to fix the clip and the wiper blade body respectively, so that the stability of the product can be effectively improved, and the effect of removing impurities such as rain and snow by the product can be improved. Meanwhile, the noise can also be reduced, and the user experience can be improved.

### BRIEF DESCRIPTION OF THE DRAWINGS

In order to explain the technical solutions of the embodiments of the present disclosure more clearly, the following will briefly introduce the accompanying drawings used in the embodiments. The drawings in the following description are only some embodiments of the present disclosure. Those of ordinary skill in the art can obtain other drawings based on these drawings without creative work.

The present disclosure is further described below in detail in combination with the accompanying drawings and embodiments.

FIG. 1 is a schematic diagram of an entire structure of the present disclosure in an angle;

FIG. 2 is a schematic diagram of an entire structure of the present disclosure in another angle;

FIG. 3 is a structural exploded diagram of the present disclosure in an angle;

FIG. 4 is a structural exploded diagram of the present disclosure in another angle;

FIG. 5 is a partially cross-sectional view of the present disclosure;

FIG. 6 is a partially cross-sectional view of an exploded state of the present disclosure;

FIG. 7 is a cross-sectional view of the present disclosure;

FIG. 8 is a schematic structural diagram of a fixed shell of the present disclosure;

FIG. 9 is a schematic structural diagram of a connecting shell and a rotary cover body of the present disclosure in an angle; and

FIG. 10 is a schematic structural diagram of a connecting shell and a rotary cover body of the present disclosure in another angle.

### DETAILED DESCRIPTION OF THE EMBODIMENTS

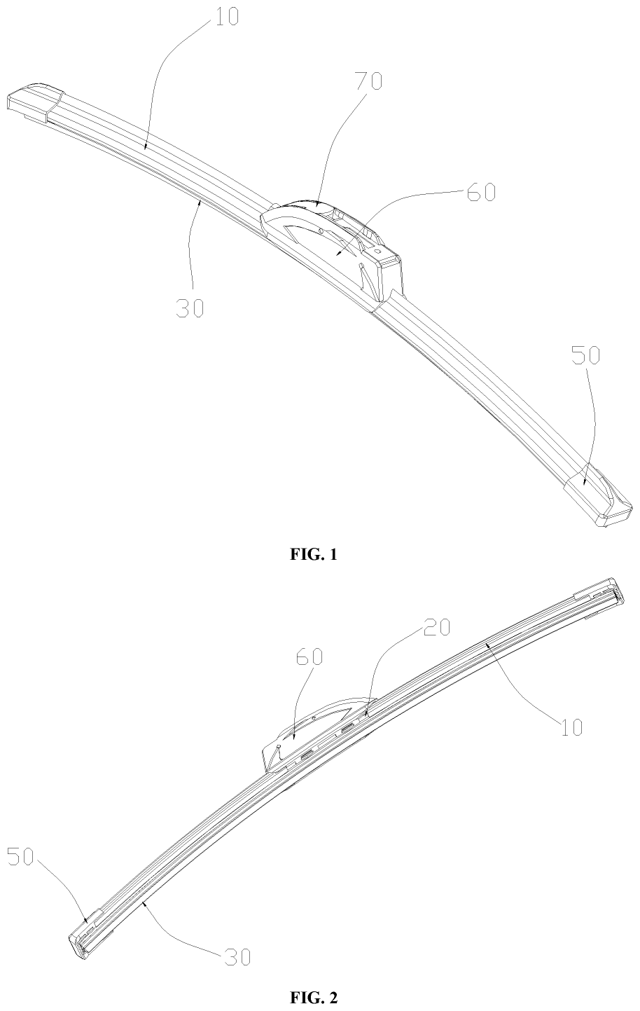

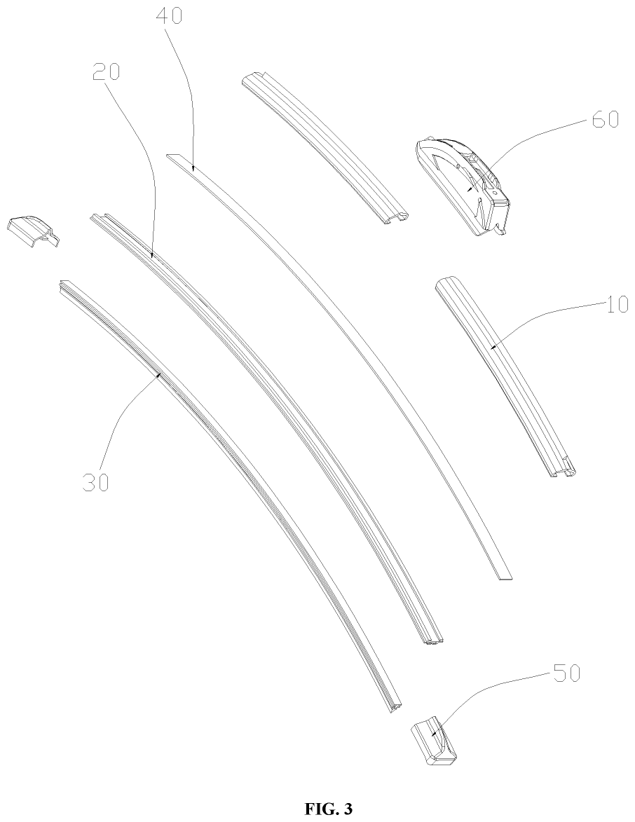

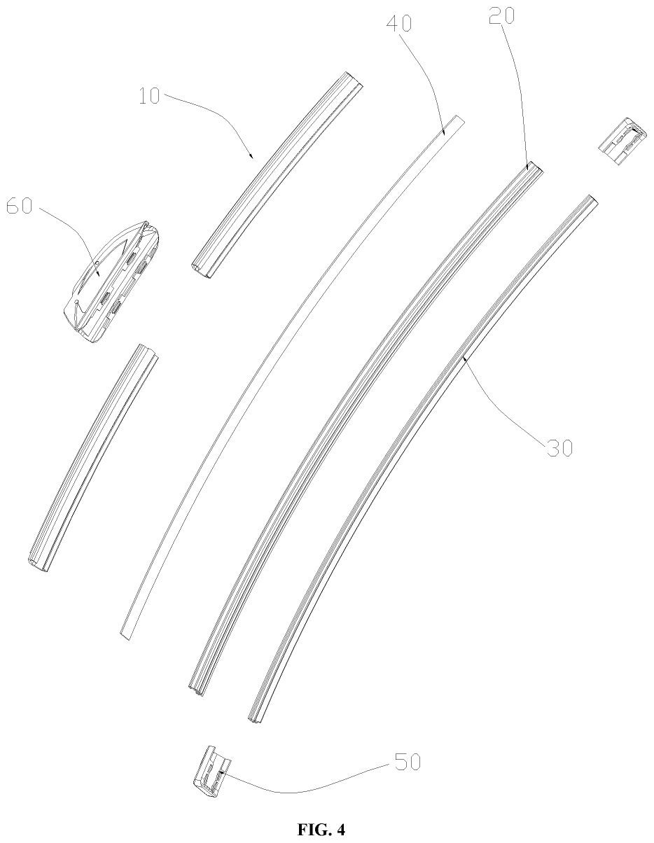

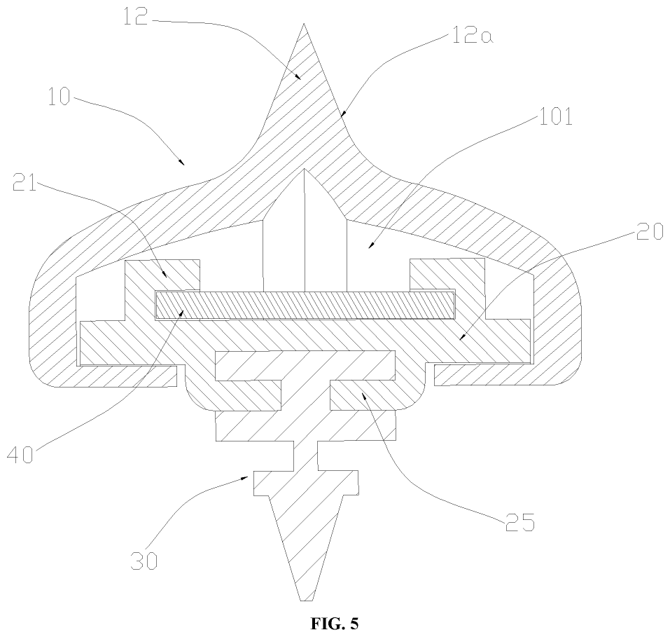

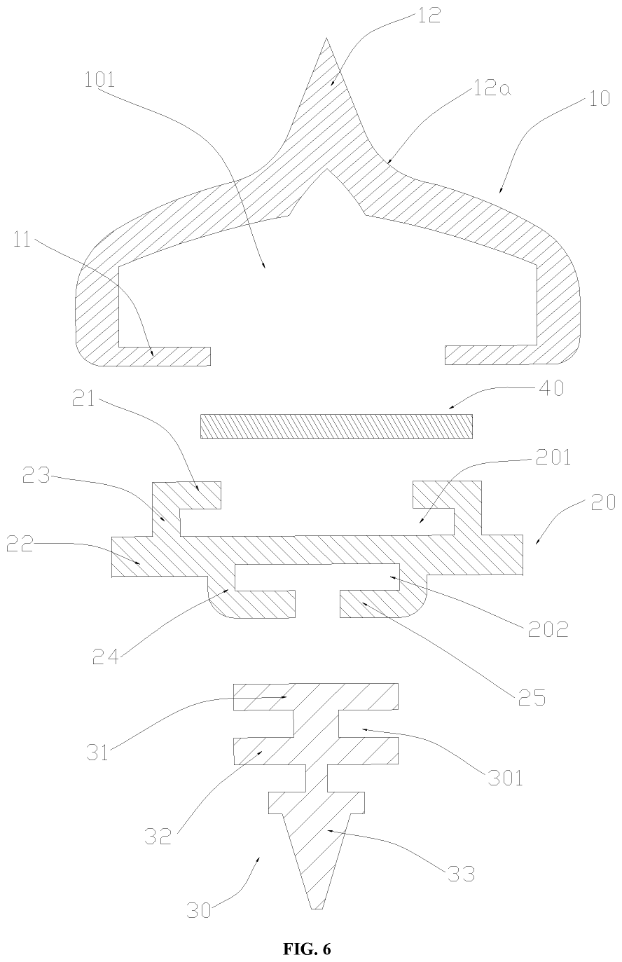

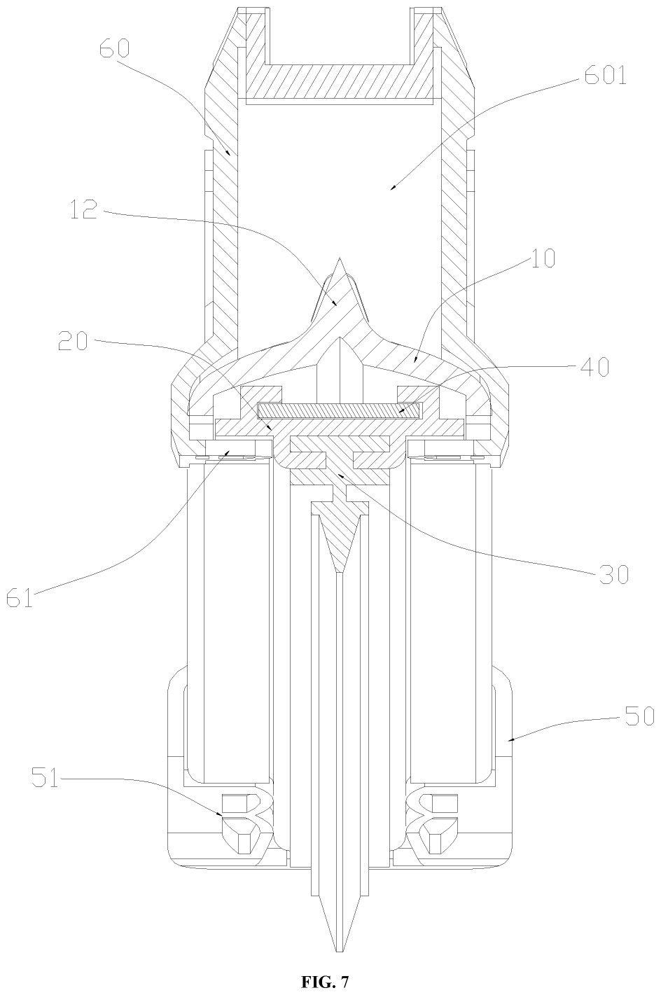

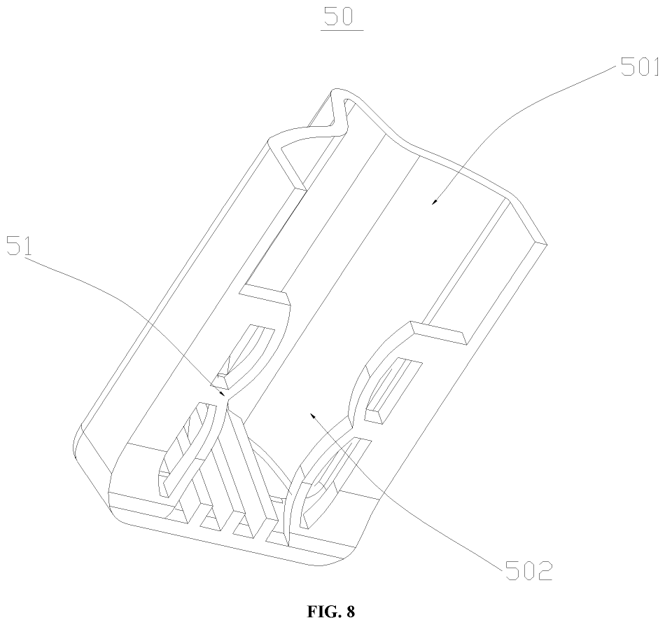

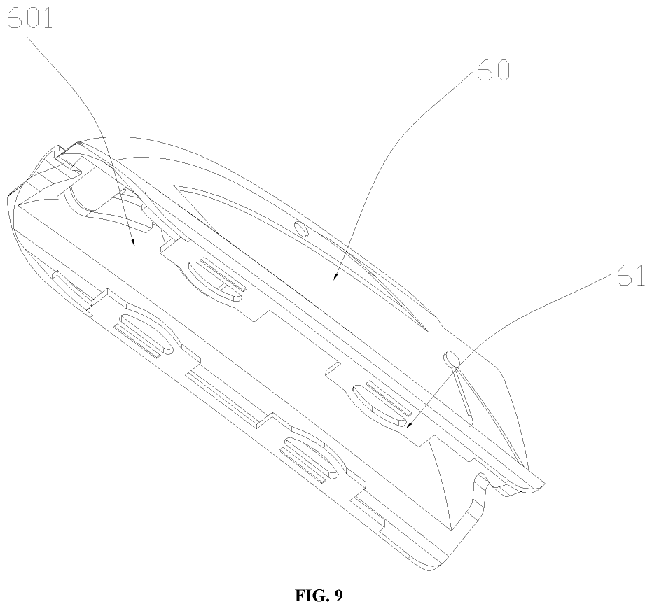

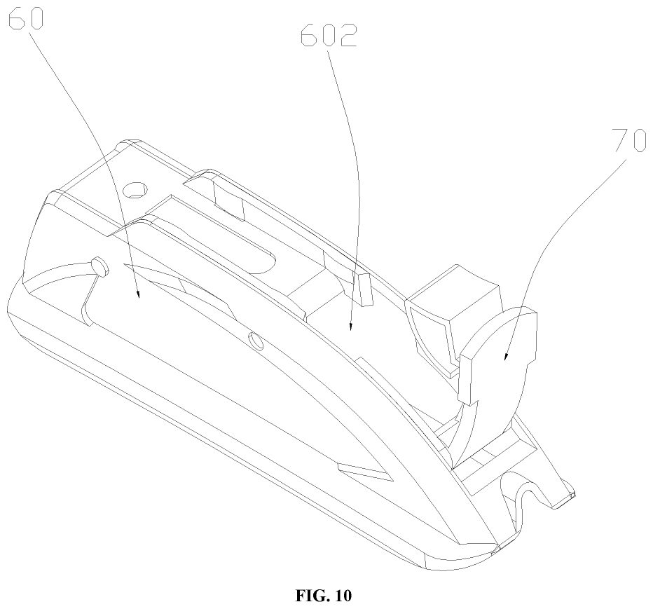

Referring to FIG. 1 to FIG. 10, a wiper blade includes:
a flow guide shell 10, wherein a lower part of the flow guide shell 10 is provided with an accommodating groove 101;
a connecting shell 20, wherein an upper surface of the connecting shell 20 is provided with a clip mounting groove 201; a lower surface of the connecting shell 20 is provided with a wiper blade body mounting groove 202; the connecting shell 20 is inserted into the accommodating groove 101 to connect the clip mounting groove 201 to the accommodating groove 101;
a wiper blade body 30, wherein the wiper blade body 30 is inserted into the wiper blade body mounting groove 202; and
a clip 40, wherein the clip 40 is inserted into the clip mounting groove 201; a first limiting block 21 is arranged on an inner wall of the clip mounting groove 201; and a lower surface of the first limiting block 21 resists against an upper surface of the clip 40.

Through the arrangement of the above structure, during use, the clip 40 is mounted in the clip mounting groove 201; and the lower surface of the first limiting block 21 resists against the upper surface of the clip 40, which can limit the clip 40 in the clip mounting groove 201 and effectively fix the clip 40. The wiper blade body 30 is inserted into the blade mounting groove 202, which can fix the wiper blade body 30. The flow guide shell 10 can effectively protect the connecting shell 20. The clip 40 is arc-shaped and has a certain curvature. When driven by an external force, the wiper blade body 30 can tightly abut against a surface of a windshield, and forces on all parts of the wiper blade body can be uniform, ensuring the usage effect of the product, ensuring that the wiper blade can effectively remove water and other impurities from the surface of the windshield, and ensuring that a user can observe road conditions through the windshield. Moreover, the connecting shell 20 is used to fix the clip 40 and the wiper blade body 30 respectively, so that the stability of the product can be effectively improved, and the effect of removing impurities such as rain and snow by the product can be improved. Meanwhile, the noise can also be reduced, and the user experience can be improved. The wiper blade body is generally a rubber strip. The rubber strip can be inexpensive and has a good water removal effect. The flow guide shell 10 is divided into two parts which respectively sleeve the connecting shell 20 and the clip 40 along two ends. The clip 40 and the connecting shell 20 which are exposed between the two flow guide shells 10 form connection positions for connecting a wiper arm and facilitating the mounting of the product.

In this embodiment, an extension direction of a lower surface of the first limiting block 21 is matched with an extension direction of a groove bottom plane of the clip mounting groove 201; and the clip 40 is clamped between the lower surface of the first limiting block 21 and the groove bottom plane of the clip mounting groove 201. Through the arrangement of the above structure, during use, the extension direction of the lower surface of the first limiting block 21 and the extension direction of the groove bottom plane of the slot of the clip mounting groove 201 are basically the same and are basically parallel to each other. Therefore, when the clip 40 is arranged in the clip mounting groove 201, the lower surface of the first limiting block 21 can fully abut against the upper surface of the clip 40, to enlarge a contact area between the first limiting block 21 and the clip 40; and the position of the clip 40 is limited, so that the lower surface of the clip 40 completely abuts against the groove bottom plane of the clip mounting groove 201, which can effectively fix the clip 40, prevent the clip from being separated from the clip mounting groove 201, ensure the stability of the product, and stably connect the clip 40 to the connecting shell 20.

In this embodiment, the connecting shell 20 includes a first wall 22; two sides of the first wall 22 extend upwards to form first side walls 23; upper parts of the two first side walls 23 extend towards each other to form the first limiting block 21; and the clip mounting groove 201 is formed between an upper surface of the first wall 22, inner surfaces of the first side walls 23, and the lower surface of the first limiting block 21. Through the arrangement of the above structure, the first side walls 23 extends upwards on the upper surface of the first wall 22, so that the clip mounting groove 201 can have a certain depth to accommodate the clip 40. Furthermore, the upper parts of the first side walls 23 extend inwards to form the first limiting block 21, so that an insertion space can be formed between the upper surface of the first wall 22 and the lower surface of the first limiting block 21, where a height of the insertion space matches a thickness of the clip 40, and a distance between the two first side walls 23 matches a width of the clip 40, which can further limit the clip 40 and improve the stability of the product.

In this embodiment, the two sides of the first wall 22 extend downwards to form second side walls 24; lower parts of the two second side walls 24 extend towards each other to form a second limiting block 25; and the wiper blade body mounting groove 202 is formed between a lower surface of the first wall 22, inner surfaces of the second side walls 24, and an upper surface of the second limiting block 25. Through the arrangement of the above structure, the inner surfaces of the second side walls 24 and the upper surface of the second limiting block 25 can limit the wiper blade body 30 in a vertical direction, and the two opposite second side walls 24 can limit the wiper blade body 30 in a horizontal direction. This further improves the stability of the connection between the wiper blade body 30 and the connecting shell 20, so that the wiper blade body 30 can be in stable contact with the surface of the windshield under a force, and the wiping ability of the product is improved.

In this embodiment, the wiper blade body 30 is provided with an insertion part 31, and the insertion part 31 is detachably inserted into the wiper blade body mounting groove 202. Through the arrangement of the above structure, the insertion part 31 is detachably mounted in the wiper blade body mounting groove 202, so that the user can freely replace the wiper blade body 30, which prolongs the service life of the product and reduces the cost. The user only needs to replace the wiper blade body 30 to achieve long-term use without the need of replacing the entire product, so that the economic pressure of the user is reduced.

In this embodiment, the wiper blade body 30 further includes a fixed part 32 and a wiping part 33; the fixed part 32 is connected to a lower part of the insertion part 31; the wiping part 33 is connected to one side of the fixed part 32 facing away from the insertion part 31; a locking groove 301 is formed between the insertion part 31 and the fixed part 32; and the second limiting block 25 is inserted into the locking groove 301. Through the arrangement of the above structure, the locking groove 301 formed between the insertion part and the fixed part 32 can be effectively clamped on the upper and lower surfaces of the second limiting block 25, which further stably connect the wiper blade body 30 to the connecting shell 20. Furthermore, when the product wipes back and forth the surface of the windshield, a supporting force can be provided for the wiping part 33 to prevent excessive deformation of the wiping part 33. This can effectively ensure that the wiping part 33 can stably abut against the surface of the windshield and can improve the usage effect of the product.

In this embodiment, the wiping part 33 is arranged in an inverted cypress shape, and a width of a lower part of the wiping part 33 is less than a width of an upper part of the wiping part 33. Through the arrangement of the above structure, the wiping part 33 is in the inverted cypress shape. When the product wipes back and forth the surface of the windshield, two side surfaces of the wiping part 33 can form acute angles with the surface of the windshield. The wider upper part of the wiping part 33 can wipe away large impurities, and the narrower lower part of the wiping part 33 can tightly abut against the surface of the windshield, which improves the ability of wiping rainwater.

In this embodiment, two edges of the accommodating groove 101 extend inwards to form a third limiting block 11, and an upper surface of the third limiting block 11 resists against an edge of the lower surface of the first wall 22. Through the arrangement of the above structure, the third limiting block 11 can effectively fix the connecting shell 20 and the flow guide shell 10, so that the stability of the product is improved, and the assembling of the product is facilitated.

In this embodiment, a side surface of the first wall 22 resists against a side wall surface of the accommodating groove 101; and outer surfaces of the first side walls 23 and/or an upper surface of the first limiting block 21 resist/resists against an upper wall surface of the accommodating groove 101. Through the arrangement of the above structure, during use, the side surface of the first wall 22 resists against the side wall surface of the accommodating groove 101, which can limit the connecting shell 20 in the horizontal direction to prevent the connecting shell 20 from shaking in the horizontal direction in the accommodating groove 101, thereby preventing the wiper blade body from shaking on the surface of the windshield and ensuring the rainwater wiping effect of the product. The outer surfaces of the first side walls 23 and/or the upper surface of the first limiting block 21 resist/resists against the upper wall surface of the accommodating groove 101. This can limit the connecting shell 20 in the vertical direction in conjunction with the third limiting block 11 resisting against the lower surface of the first wall 22, so that the wiper blade body 30 can be in more stable contact with the surface of the windshield.

In this embodiment, a protruding wind bearing part 12 is arranged in the middle of an upper surface of the flow guide shell 10, and symmetrical arc-shaped transition surfaces 12a are arranged on two sides of the wind bearing part 12. Through the arrangement of the above structure, during use, the product wipes back and forth the surface of the windshield, and an air flow flows along surfaces of the arc-shaped transition surfaces 12a, so that a force facing the air flow is converted into a force applied by the wiper blade body to the windshield, and the wiper blade body tightly abuts against the surface of the windshield. This further improves the rainwater wiping effect of the product.

In this embodiment, the wiper blade further includes two fixed shells 50; the fixed shells 50 are provided with first insertion slots 501, and an end portion of the flow guide shell 10, an end portion of the connecting shell 20, an end portion of the wiper blade body 30, and an end portion of the clip 40 are inserted into the first insertion slots 501. Through the arrangement of the above structure, the two fixed shells 50 can fix the end portion of the flow guide shell 10, the end portion of the connecting shell 20, the end portion of the wiper blade body 30, and the end portion of the clip 40 in the first insertion slots 501, which can effectively protect the end portion of the flow guide shell 10, the end portion of the connecting shell 20, the end portion of the wiper blade body 30, and the end portion of the clip 40, ensure the stability of the product, and effectively prevent the wiper blade body 30 from being separated from the connecting shell 20 and the flow guide shell 10, so that the product is firmer and more durable.

In this embodiment, the fixed shells 50 further include openings 502; the openings 502 are communicated to the first insertion slots 501; and the wiper blade body 30 penetrates through the openings 502. Through the arrangement of the above structure, during use, the openings 502 can allow the wiper blade body 30 to pass through, so that an end portion of the product end also has a protruding wiper blade body 30, and the end portion of the product can also effectively wipe the surface of the windshield. This improves the water and dust removal effect of the product, and the product is more convenient to use.

In this embodiment, first locking parts 51 are arranged on two sides of the fixed shells 50 close to the openings 502, and the first locking parts 51 are connected to the clip 40 and/or the connecting shell 20. Through the arrangement of the above structure, the first locking parts 51 can fix the fixed shells 50 with the clip 40 and/or the connecting shell 20 to prevent the fixed shells 50 from being separated. This further ensures the stability of the product. Meanwhile, the relative positions of the clip 40, the connecting shell 20, the flow guide shell 10, and the wiper blade body 30 can be limited, so that the product is firmer and more durable and is convenient to assemble, improving the assembling and production efficiency of the product.

In this embodiment, the wiper blade further includes a connecting shell 60; a lower part of the connecting shell 60 is connected to the middle of the clip 40 and/or the middle of the connecting shell 20; and an upper part of the connecting shell 60 is configured to be connected to a wiper arm. Through the arrangement of the above structure, the connecting shell 60 is arranged in the middle of the product, which can balance the force on the product. Furthermore, the wiper arm drives the connecting shell 20 and the clip 40, causing the curved clip 40 to slightly deform, thereby making forces applied to the wiper blade body 30 by all the parts of the clip 40 close to each other and enabling the blade stably to be in more stable contact with the surface of the windshield. The force on the product is uniform. The product is smoother as the wiper arm swings back and forth. This improves the smoothness of usage of the product and improves the user experience.

In this embodiment, the connecting shell 60 is provided with a second insertion slot 601; a second locking part 61 is arranged at an edge of the second insertion slot 601; the flow guide shell 10 and the connecting shell 20 are inserted into the second insertion slot 601; and the second locking part 61 is connected to the clip 40 and/or the connecting shell 20. Through the arrangement of the above structure, the second insertion slot 601 can allow part of the clip 40 and part of the connecting shell 20 to be inserted, which enlarges the contact area and ensures the connection strength. The second locking part 61 can be locked on the clip 40 and/or the connecting shell 20, which effectively improves the stability of connection, so that the wiper arm can stably drive the product to move back and forth.

In this embodiment, the wiper blade further includes a rotary cover body 70; a connecting opening 602 is arranged at the upper part of the connecting shell 60; the rotary cover body 70 is rotatably connected to the connecting shell 60 and opens or closes the connecting opening 602; and the connecting opening 602 is configured to allow the wiper arm to be connected for use. Through the arrangement of the above structure, during use, the rotary cover body 70 is rotated to open the connecting opening 602, which allows a connecting part of the wiper arm to pass through and makes it convenient for the user to connect the product. In a storage state, the rotary cover body 70 can be rotated to close the connecting opening 602, which can protect connecting structures inside the second insertion slot 601, ensure the stability of the product, and reduce the loss of the user.

In this embodiment, the flow guide shell 10, the connecting shell 20, the wiper blade body 30, and the clip 40 are all arranged in an arc shape. Through the arrangement of the above structure, the flow guide shell 10, the connecting shell 20, the wiper blade body 30, and the clip 40 are all arranged in the arc shape, and their radians match the radian of the surface of the windshield. This can effectively ensure the stable contact between the wiper blade body 30 and the surface of the windshield, improve the ability of the product for wiping away impurities such as rainwater, and improve the usage effect of the product.

One or more implementation modes are provided above in combination with specific contents, and it is not deemed that the specific implementation of the present disclosure is limited to these specifications. Any technical deductions or replacements approximate or similar to the method and structure of the present disclosure or made under the concept of the present disclosure shall fall within the scope of protection of the present disclosure.

What is claimed is:

1. A wiper blade, comprising:
a flow guide shell, wherein a lower part of the flow guide shell is provided with an accommodating groove;
a connecting shell, wherein an upper surface of the connecting shell is provided with a clip mounting groove; a lower surface of the connecting shell is provided with a wiper blade body mounting groove; the connecting shell is inserted into the accommodating groove to connect the clip mounting groove to the accommodating groove;
a wiper blade body, wherein the wiper blade body is inserted into the wiper blade body mounting groove; and
a clip, wherein the clip is inserted into the clip mounting groove; a first limiting block is arranged on an inner wall of the clip mounting groove; and a lower surface of the first limiting block resists against an upper surface of the clip.

2. The wiper blade according to claim 1, wherein an extension direction of a lower surface of the first limiting block is matched with an extension direction of a groove bottom plane of the clip mounting groove; and the clip is clamped between the lower surface of the first limiting block and the groove bottom plane of the clip mounting groove.

3. The wiper blade according to claim 1, wherein the connecting shell comprises a first wall; two sides of the first wall extend upwards to form first side walls; upper parts of the two first side walls extend towards each other to form the first limiting block; and the clip mounting groove is formed between an upper surface of the first wall, inner surfaces of the first side walls, and the lower surface of the first limiting block.

4. The wiper blade according to claim 3, wherein the two sides of the first wall extend downwards to form second side walls; lower parts of the two second side walls extend towards each other to form a second limiting block; and the wiper blade body mounting groove is formed between a lower surface of the first wall, inner surfaces of the second side walls, and an upper surface of the second limiting block.

5. The wiper blade according to claim 4, wherein the wiper blade body is provided with an insertion part, and the insertion part is detachably inserted into the wiper blade body mounting groove.

6. The wiper blade according to claim 5, wherein the wiper blade body further comprises a fixed part and a wiping part; the fixed part is connected to a lower part of the insertion part; the wiping part is connected to one side of the fixed part facing away from the insertion part; a locking groove is formed between the insertion part and the fixed part; and the second limiting block is inserted into the locking groove.

7. The wiper blade according to claim 6, wherein the wiping part is arranged in an inverted cypress shape, and a width of a lower part of the wiping part is less than a width of an upper part of the wiping part.

8. The wiper blade according to claim 3, wherein two edges of the accommodating groove extend inwards to form a third limiting block, and an upper surface of the third limiting block resists against an edge of the lower surface of the first wall.

9. The wiper blade according to claim 3, wherein a side surface of the first wall resists against a side wall surface of the accommodating groove; and outer surfaces of the first side walls and/or an upper surface of the first limiting block resist/resists against an upper wall surface of the accommodating groove.

10. The wiper blade according to claim 1, wherein a protruding wind bearing part is arranged in the middle of an upper surface of the flow guide shell, and symmetrical arc-shaped transition surfaces are arranged on two sides of the wind bearing part.

11. The wiper blade according to claim 1, further comprising two fixed shells, wherein the fixed shells are provided with first insertion slots, and an end portion of the flow guide shell, an end portion of the connecting shell, an end portion of the wiper blade body, and an end portion of the clip are inserted into the first insertion slots.

12. The wiper blade according to claim 11, wherein the fixed shells further comprise openings; the openings are communicated to the first insertion slots; and the wiper blade body penetrates through the openings.

13. The wiper blade according to claim 12, wherein first locking parts are arranged on two sides of the fixed shells close to the openings, and the first locking parts are connected to the clip and/or the connecting shell.

14. The wiper blade according to claim 1, further comprising a connecting shell, wherein a lower part of the connecting shell is connected to the middle of the clip and/or the middle of the connecting shell; and an upper part of the connecting shell is configured to be connected to a wiper arm.

15. The wiper blade according to claim 14, wherein the connecting shell is provided with a second insertion slot; a second locking part is arranged at an edge of the second insertion slot; the flow guide shell and the connecting shell are inserted into the second insertion slot; and the second locking part is connected to the clip and/or the connecting shell.

16. The wiper blade according to claim 14, further comprising a rotary cover body, wherein a connecting opening is arranged at the upper part of the connecting shell; the rotary cover body is rotatably connected to the connecting shell and opens or closes the connecting opening; and the connecting opening is configured to allow the wiper arm to be connected for use.

17. The wiper blade according to claim 1, wherein the flow guide shell, the connecting shell, the wiper blade body, and the clip are all arranged in an arc shape.
